(19) United States
(12) Patent Application Publication
(10) Pub. No.: US 2015/0127566 A1
(43) Pub. Date: May 7, 2015

(54) INTERACTIVE GROUP PERSONNEL INFORMATION RETRIEVAL AND COMMUNICATION

(71) Applicant: CONOCOPHILLIPS COMPANY, Houston, TX (US)

(72) Inventors: Darryl S. ANDREWS, Houston, TX (US); Janet L. KELLY, Houston, TX (US)

(21) Appl. No.: 14/522,269

(22) Filed: Oct. 23, 2014

Related U.S. Application Data
(60) Provisional application No. 61/898,717, filed on Nov. 1, 2013.

(51) Int. Cl. G06Q 10/10

(52) U.S. Cl. CPC G06Q 10/105
USPC 705/320

(57) ABSTRACT

Methods for managing an interactive personnel directory are disclosed. Example of a method includes providing a database of personnel records that includes contact information, the database being resident on a non-transitory storage medium of a host computer or a mobile device; processing an authority code that defines user-specific privileges, wherein the authority code is configured to provide personnel record of a selected contact to the user upon request and within the defined user-specific privileges; and providing a user-interface configured to allow the user to contact the selected contact via the host computer or mobile device by selecting the contact information on the personnel record of the selected contact.

### CROSS-REFERENCE TO RELATED APPLICATIONS

This application is a non-provisional application which claims benefit under 35 USC §119(e) to U.S. Provisional Application Ser. No. 61/898,717 filed Nov. 1, 2013, entitled “INTERACTIVE GROUP PERSONNEL INFORMATION RETRIEVAL AND COMMUNICATION,” which is incorporated herein in its entirety.

### FIELD OF THE INVENTION

The present invention relates generally to data management and in particular to methods and tools for providing an interactive personnel directory.

### BACKGROUND OF THE INVENTION

Many businesses or other organizational enterprises (e.g., governmental or educational entity) maintain personnel directories so that its members can search and contact other members within the organization. A typical organization can have many members or employees who are reachable by their respective telephone extensions, email addresses, mail boxes, as well as social media pages. These directories are important to ensure that the members within the organization are able to efficiently search and locate other members whenever communication is needed. Directories can also be particularly useful during emergencies (e.g., catastrophic events) when quickly notifying response units as well as other staff members are critical.

More recently, personnel directories have become increasingly important for organizations of various sizes. Many large organizations centrally store their personnel information in an online or web directory that is accessible via the web. The online or web directory is usually searchable by a member's name (first and/or last) and can display key information such as contact telephone number, email address, office address, job title, and the like. While conventional online directories greatly ease the process of searching and locating members within the organization, there are several problems that limit its overall effectiveness. For security reasons, some conventional directories can only be accessed through a computer connected to a company or organization's intranet. However, there are many scenarios where the user (e.g., personnel out on field assignments in remote regions) needs to locate a contact record but does not readily have access to a computer, internet, and/or intranet. Moreover, some conventional directories do not allow the user to directly contact the selected contact or his/her supervisor(s) and subordinate(s) from the displayed personnel record.

### BRIEF SUMMARY OF THE DISCLOSURE

The present invention relates generally to data management and in particular to methods and tools for providing an interactive personnel directory.

One example of a method of managing an interactive personnel directory comprises the steps of: providing a database of personnel records that includes contact information, the database being resident on a non-transitory storage medium of a host computer or a mobile device; processing an authority code that defines user-specific privileges, wherein the authority code is configured to provide personnel record of a selected contact to the user upon request and within the defined user-specific privileges; and providing a user-interface configured to allow the user to contact the selected contact via the host computer or mobile device by selecting the contact information on the personnel record of the selected contact.

An example of a method of operating an interactive personnel directory comprises the steps of: processing an authority code that defines user-specific privileges, wherein the authority code is configured to provide personnel record of a selected contact to the user upon request and within the defined user-specific privileges; and providing a user-interface configured to allow the user to contact the selected contact via the mobile device by selecting the contact information on the personnel record of the selected contact.

An example of an interactive personnel directory system comprises: a mobile device that includes a non-transitory storage medium storing a database of personnel records, each personnel record including one or more of: telephone number, email address, instant messaging username, contact photograph, supervisor contact information, subordinate contact information, and any combination thereof; an authority code processor defining user privileges for a user and defining user-specific privileges, wherein the authority code processor provides access to selected contact records of a selected contact to the user upon request and within the defined user privileges; and a user-interface that allows the user to contact the selected contact via the mobile device.

An example of a non-transitory storage medium on a mobile device comprises instructions for: accessing a database of personnel records that includes contact information; processing an authority code that defines user-specific privileges, wherein the authority code is configured to provide personnel record of a selected contact to the user upon request and within the defined user-specific privileges; and providing a user-interface configured to allow the user to contact the selected contact via the mobile device by selecting the contact information on the personnel record of the selected contact.

### BRIEF DESCRIPTION OF THE DRAWINGS

A more complete understanding of the present invention and benefits thereof may be acquired by referring to the follow description taken in conjunction with the accompanying drawings in which:

FIG. 1 is a flow chart illustrating an embodiment of the present invention.

FIG. 2 is a flow chart illustrating an embodiment of the present invention.

FIG. 3 is a flow chart illustrating an embodiment of the present invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations that come within the scope of the invention.

The present invention provides methods and systems for providing a user with an interactive personnel directory of members of a group (e.g., company) on a personal computing device. As used herein, the term “interactive personnel directory” refers to a directory having a database that can be, for example, queried, searched, and sorted by the user. The interactive directory of the present invention can be uploaded directly onto the personal computing device (e.g., mobile device, wireless device, portable computer, etc.) wherein contents of the directory can be updated periodically. As such, the contents of the interactive directory may be accessible to the user without requiring internet and/or intranet connection. Furthermore, the present invention provides an interface that allows a user to easily interact with a contact through any number of communication mediums (e.g., email, phone, internet voice call, etc.) on the personal computing device. Other advantages will be apparent from the disclosure herein.

As used herein, the term “mobile device” refers to a wireless device equipped with a display screen, a microprocessor, and an input interface. Examples of mobile devices include, but are not limited to, telephones, cellular phones, tablets, watches, glasses, etc. Typically, a mobile device is capable to being connected to at least one of: internet, intranet, cellular telephone network, two-way radio (duplex communication) including full-duplex, half-duplex, time-division duplex, or frequency-division duplex communication, or any other wireless network or connection that can transmit data. A mobile device can also have features such as, but not limited to, Wi-fi, Bluetooth, GPS, non-transitory storage medium and are typically powered by one or more batteries that can be recharged. Suitable examples of commercially available mobile devices include, but are not limited to, iPhone®, iPad®, iPod touch® (sold by Apple Inc, Cupertino, Calif.).

Some embodiments provide a method of managing an interactive personnel directory comprising: providing a database of personnel records that includes contact information, the database being resident on a non-transitory storage medium of a host computer or a mobile device; processing an authority code that defines user-specific privileges, wherein the authority code is configured to provide personnel record of a selected contact to the user upon request and within the defined user-specific privileges; and providing a user-interface configured to allow the user to contact the selected contact via the host computer or mobile device by selecting the contact information on the personnel record of the selected contact.

As used herein, the term “user” and its related terms such as “user-specific” and “user-interface” refer to the individual or individuals interacting (e.g., querying, searching, sorting, etc.) with the interactive personnel directory. As used herein, the term “contact” and its related terms such “selected contact” refer to the individual or individuals whose information is stored in the database and being requested by the user. As used herein, the term “personnel” and its related terms such as “personnel records” refer to the individual or individuals within a grouping or organization. As used herein, the term “applet” refers to a widget or application that performs one or more specific tasks on the personal computing device. An applet can be executed and/or may be compatible on multiple platforms.

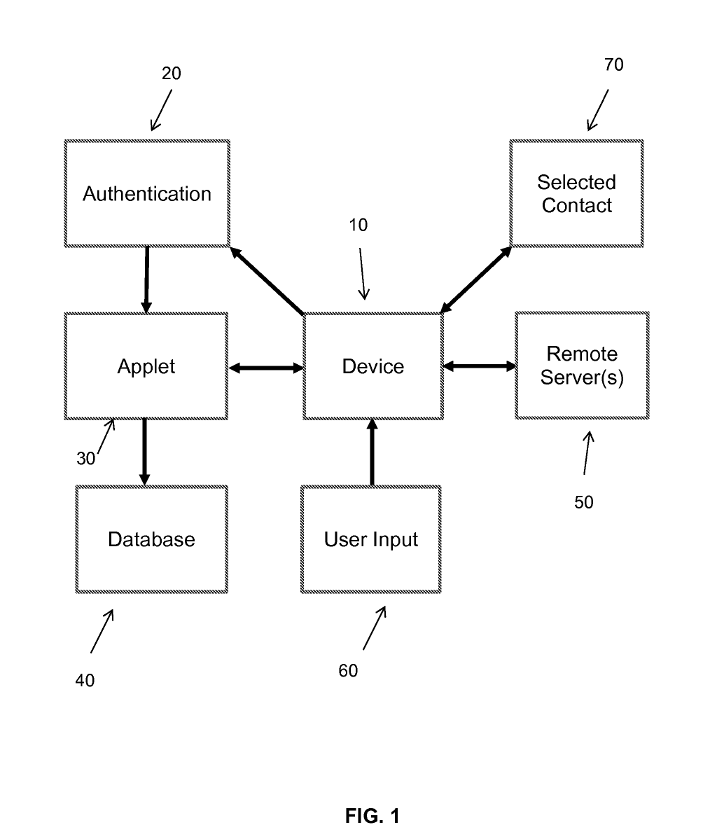

Referring to the embodiment shown in FIG. 1, a device 10 (e.g., personal computing device) is used as a host to install an applet 20 that contains instructions for managing or operating an embodiment of the interactive personnel directory according to the present invention. In order to access the applet 30 and the database 40, the user 60 must first pass the authentication process 20. The authentication is performed by an authority code that defines user-specific privileges that limits or otherwise controls access to the database. In some embodiments, the authentication process can utilize a password protection screen on the mobile device 10, a security validation key provided on, for example, company-issued personal computing device, or any other compatible electronic security means. Once a user 60 is authenticated, he can download and/or access an installed applet 30 that contains or has access to the database 40 of personnel records. The database 40 may be stored locally on the mobile device 10 or on a remote server 50 (e.g., web server). The remote server 50 can provide several updates to the applet 30 and/or database 40. For example, updates to the applet 30 and/or database 40 can be made by remote server 50 via communication with the device 10. Referring still to FIG. 1, the user 60 can query the database 40 by entering input into the device 10 via a user-interface provided by the applet 30. In some embodiments, the user-interface may be keyboard-based, touch-based (via touchscreen on or connected to the device), voice-based (via microphone on or connected to the device), motion-based (via camera on or connected to the device), or any other suitable means. The device 10 can display results of the query (e.g., a listing of personnel records) and also allow the user 60 to directly contact or otherwise interact with the selected contact(s) by one or more of: voice call, email, instant message, and the like. In some embodiments, the remote servers can maintain a mirror database that includes updated personnel records. The mirror database can be maintained and monitored periodically or as needed. Moreover, the remote server(s) can be used to send global notifications, selected notifications, emergency notifications, and the like. The selected and emergency notifications may be sent out to a select subset of personnel whose contact information are stored in the database.

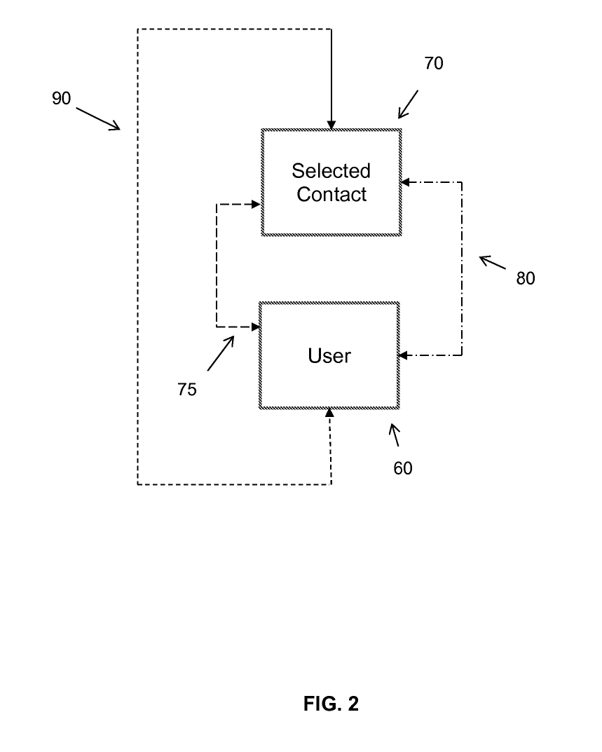

Each personnel record may include contact information selected from the group consisting of: telephone number, email address, instant messaging username, contact photograph, supervisor contact information, subordinate contact information, and any combination thereof. In some embodiments, retrieving the personnel record of the selected contact can provide a history of all interactions (e.g., email communications, voicemails, phone calls, instant messages) between the user and the selected contact. Referring to the specific embodiment shown in FIG. 2, accessing the personnel record of the selected contact 70 displays at least a partial history of the interactions and/or communications (e.g., emails 75, telephone calls 80, instant messages 90, etc.) between the user 60 and the selected contact 70. For example, this history view can also allow the user to query, search, and/or sort through all prior email communications between the user and the selected contact. The email communications are not necessarily limited to those emails locally stored on the device but may also include emails resident on a remote server.

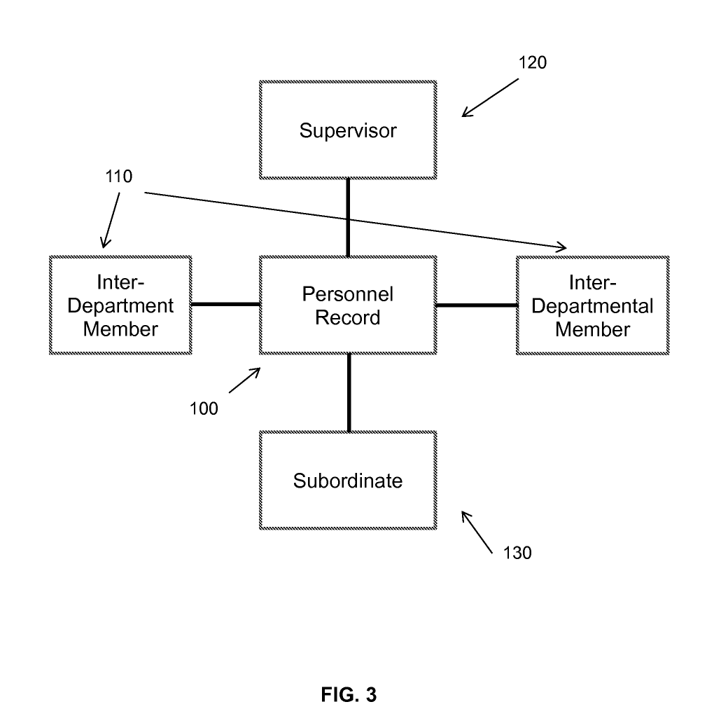

Referring to the specific embodiment illustrated in FIG. 3, the interactive personnel directory can also allow a user to query, search, and/or select easily within a group such as a department by providing direct links to the selected contact's supervisor personnel record and/or subordinate personnel record. Fellow members (e.g., inter-departmental members 110) of a specified grouping (e.g., within a department) may be conveniently scrolled through using the user-interface of the device. In such embodiments, each personnel record may include a summary view and a detailed view. In the summary view, the personnel record may display, for example, contact photograph, contact name, and the like. In some embodiments, the user can electronically scroll (e.g., using a swiping motion on a touchscreen of a mobile device) through personnel records displaying summary views. Selecting a specific personnel record displays the detailed view which shows further contact information and optionally, a history of communication and/or interaction between the user and the selected contact.

Some embodiments provide a method of operating a personnel directory comprising providing a database of personnel records, the database being resident on a non-transitory storage medium of a mobile device; processing an authority code that defines user-specific privileges, wherein the authority code is configured to provide personnel record of a selected contact to the user upon request and within the defined user-specific privileges; and providing a user-interface configured to allow the user to contact the selected contact via the mobile device by selecting the contact information on the personnel record of the selected contact.

Some embodiments provide an interactive personnel directory system comprising a mobile device that includes a non-transitory storage medium storing a database of personnel records, each personnel record including one or more of: telephone number, email address, instant messaging username, contact photograph, supervisor contact information, subordinate contact information, and any combination thereof; an authority code processor defining user privileges for a user and defining user-specific privileges, wherein the authority code processor provides access to selected contact records of a selected contact to the user upon request and within the defined user privileges; and a user-interface that allows the user to contact the selected contact via the mobile device.

Some embodiments provide a non-transitory storage medium comprising instructions for accessing a database of personnel records that includes contact information; processing an authority code that defines user-specific privileges, wherein the authority code is configured to provide personnel record of a selected contact to the user upon request and within the defined user-specific privileges; and providing a user-interface configured to allow the user to contact the selected contact via the mobile device by selecting the contact information on the personnel record of the selected contact.

In closing, it should be noted that the discussion of any reference is not an admission that it is prior art to the present invention, especially any reference that may have a publication date after the priority date of this application. At the same time, each and every claim below is hereby incorporated into this detailed description or specification as additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method of managing an interactive personnel directory comprising:
providing a database of personnel records that includes contact information, the database being resident on a non-transitory storage medium of a host computer or a mobile device;
processing an authority code that defines user-specific privileges, wherein the authority code is configured to provide personnel record of a selected contact to the user upon request and within the defined user-specific privileges; and
providing a user-interface configured to allow the user to contact the selected contact via the host computer or mobile device by selecting the contact information on the personnel record of the selected contact.

2. The method of claim 1, further comprising:
maintaining a mirror database that includes updated personnel records on a remote server, the mirror database periodically updating the database resident on the host computer or mobile device.

3. The method of claim 1, wherein the mobile device is selected from the group consisting of: a phone, a smartphone, a tablet, and any combination thereof.

4. The method of claim 1, wherein the contact information is selected from the group consisting of: telephone number, email address, instant messaging username, contact photograph, supervisor contact information, subordinate contact information, and any combination thereof.

5. The method of claim 1, further comprising:
providing a history of communication selected from the group consisting of:
phone calls, emails, instant messages, and any combination thereof between the user and the selected contact.

6. A method of operating an interactive personnel directory comprising:
providing a database of personnel records, the database being resident on a non-transitory storage medium of a mobile device;
processing an authority code that defines user-specific privileges, wherein the authority code is configured to provide personnel record of a selected contact to the user upon request and within the defined user-specific privileges; and
providing a user-interface configured to allow the user to contact the selected contact via the mobile device by selecting the contact information on the personnel record of the selected contact.

7. The method of claim 6, further comprising:
maintaining a mirror database that includes updated personnel records on a remote server, the mirror database periodically updating the database resident on the mobile device.

8. The method of claim 6, wherein the mobile device is selected from the group consisting of: a phone, a smart phone, a tablet, and any combination thereof.

9. The method of claim 6, wherein each contact record comprises contact information selected from the group consisting of: office telephone number, mobile telephone number, email address, instant messaging username, contact photograph, supervisor contact information, subordinate contact information, and any combination thereof.

10. The method of claim 6, further comprising:
Providing a history of communication selected from the group consisting of: phone calls, emails, instant messages, and any combination thereof between the user and the selected contact.

11. An interactive personnel directory system comprising:
a mobile device that includes a non-transitory storage medium storing a database of personnel records, each personnel record including one or more of: telephone number, email address, instant messaging username, contact photograph, supervisor contact information, subordinate contact information, and any combination thereof;
an authority code processor defining user privileges for a user and defining user-specific privileges, wherein the authority code processor provides access to selected contact records of a selected contact to the user upon request and within the defined user privileges; and
a user-interface that allows the user to contact the selected contact via the mobile device.

12. The interactive personnel directory system of claim 11, further comprising:
a mirror database that includes updated personnel records stored on a remote server, the mirror database being in communication with the database.

13. The interactive personnel directory system of claim 11, wherein the user device is selected from the group consisting of: a telephone, a smartphone, a tablet, and any combination thereof.

14. The interactive personnel directory of claim 11, further comprising: a global server that transmits one or more of: global notification, selected notification, and emergency notification, wherein the global server is in persistent or periodic communication with the user device.

15. The interactive personnel directory of claim 14, wherein the global server transmits emergency notifications based on an emergency notification tree.

16. A non-transitory storage medium comprising instructions for:
accessing a database of personnel records that includes contact information;
processing an authority code that defines user-specific privileges, wherein the authority code is configured to provide personnel record of a selected contact to the user upon request and within the defined user-specific privileges; and
providing a user-interface configured to allow the user to contact the selected contact via the mobile device by selecting the contact information on the personnel record of the selected contact.

17. The method of claim 16, further comprising:
communicating with a mirror database that includes updated personnel records on a remote server, the mirror database periodically updating the database resident on the mobile device.

18. The method of claim 16, wherein the mobile device is selected from the group consisting of: a phone, a smartphone, a tablet, and any combination thereof.

19. The method of claim 16, wherein the contact information is selected from the group consisting of: telephone number, email address, instant messaging username, contact photograph, supervisor contact information, subordinate contact information, and any combination thereof.

20. The method of claim 16, further comprising:
providing a history of communication selected from the group consisting of: phone calls, emails, instant messages, and any combination thereof between the user and the selected contact.
